(19) United States
(12) Patent Application Publication
(10) Pub. No.: US 2006/0291055 A1
(43) Pub. Date: Dec. 28, 2006

(54) Diffuse Multilayer Optical Article

(75) Inventors: Mark D. Gehlsen, Eagan, MN (US); Ryan T. Fabick, St. Paul, MN (US); Audrey A. Sherman, St. Paul, MN (US); Linda M. Rivard, Stillwater, MN (US); Dong-Wei D. Zhu, Shoreview, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/423,190

(22) Filed: Jun. 9, 2006

Related U.S. Application Data
(60) Provisional application No. 60/690,992, filed on Jun. 15, 2005.

(51) Int. Cl. G02B 5/30

(52) U.S. Cl. 359/486

(57) ABSTRACT

The disclosure describes an optical article having a reflective polarizer, a light diffusing layer, and an adhesive layer disposed between the reflective polarizer and the light diffusing layer. The adhesive layer bonds the reflective polarizer and the light diffusing layer together. The adhesive includes a (meth)acrylate monomer and a reinforcing monomer comprising an acid or base functionality.

### CROSS REFERENCE TO RELATED APPLICATION

This application claims priority from U.S. Provisional Application Ser. No. 60/690,992 by Gehlsen et al., entitled “Diffuse Multilayer Optical Article”, filed Jun. 15, 2005.

### FIELD OF THE INVENTION

The invention relates to an optical article, and more particularly, to a diffuse multilayer optical article comprising a reflective polarizing layer and a light diffusing layer that are bonded together with an adhesive layer.

### SUMMARY

The disclosure describes an optical article having a reflective polarizer, a light diffusing layer, and an adhesive layer disposed between the reflective polarizer and the light diffusing layer. The adhesive layer bonds the reflective polarizer and the light diffusing layer together. The adhesive includes a (meth)acrylate monomer and a reinforcing monomer comprising an acid or base functionality.

### BRIEF DESCRIPTION OF THE DRAWINGS

Throughout the specification, reference is made to the appended drawings, where like reference numerals designate like elements, and wherein:

FIG. 1 is a schematic cross-sectional view of an optical article;

FIG. 2 is a schematic cross-sectional view of a direct-lit display device;

FIG. 3 shows a photograph of an optical article having defects from aging experiments;

FIGS. 4A and 4B show photographs of an optical article, before and after aging experiments, respectively;

FIG. 5 shows a plot of horizontal position (m) versus the normalized change in luminance (cd/m²) for cross-sections taken from the center of each of several optical articles;

FIG. 6 shows results from aging experiments; and

FIG. 7 shows results from aging experiments.

### DETAILED DESCRIPTION

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a film” encompasses embodiments having one, two or more films. As used in this specification and the appended claims, the term “or” is generally employed in its sense including “and/or” unless the content clearly dictates otherwise.

Pressure sensitive adhesives may be used to adhere optical films to each other. However, defects such as blisters and dimples form between the optical films when the resulting optical article is subjected to extreme environmental conditions, e.g. high heat and humidity, heat/UV exposure, and thermal shock. When used in liquid crystal display (LCD) devices, for example, the blisters may appear as luminance non-uniformities. Thus, it is desirable to use adhesives that are better able to endure these extreme environmental conditions with little change in physical, mechanical, and optical performance. Resistance to changes in color is also desirable, especially for optical articles used in display devices.

In exemplary embodiments, it is desirable to utilize optical articles comprising a reflective polarizer bonded to a diffuser plate. In such exemplary embodiments, the diffuser plate is the diffusing layer referred to in the present application. Such optical articles would decrease the assembly time for LCD televisions, for example, because there would be fewer components, and the articles would be amenable to automated assembly. The present disclosure describes materials that may be used to bond a reflective polarizer to a diffuser plate that are able to withstand extreme environmental conditions as described above. Suitable diffuser plates include, for example, relatively rigid plates of a few millimeters thickness formed of any suitable material such as polycarbonate or poly methyl methacrylate (PMMA). In one embodiment, the diffuser plate may contain diffusing particles.

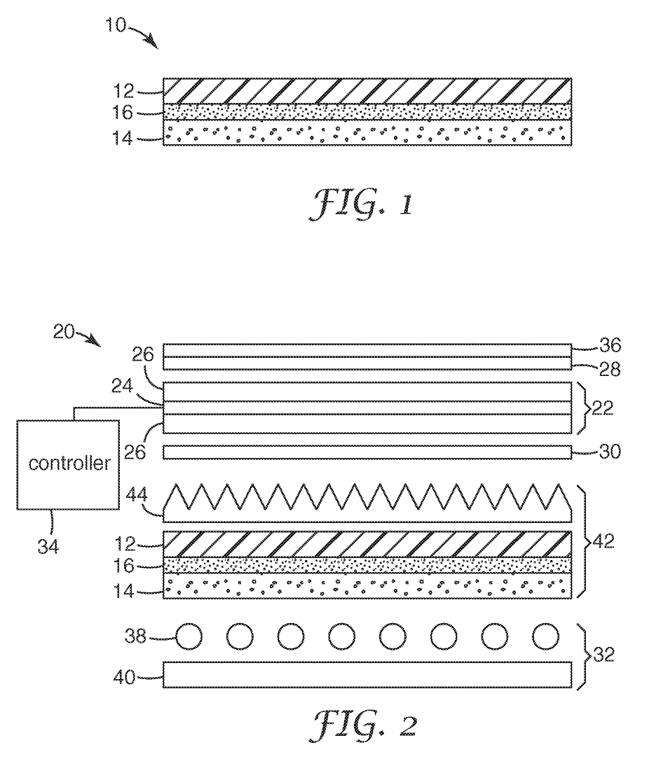

FIG. 1 shows a schematic representation of an embodiment of the optical article disclosed herein. Optical article 10 comprises reflective polarizing layer 12; a light diffusing layer 14; and an adhesive layer 16 disposed between the reflective polarizing layer 12 and the light diffusing layer 14, wherein the adhesive layer 16 bonds the reflective polarizing layer 12 and the light diffusing layer 14 together.

Reflective Polarizing Layer

Reflective polarizing layers, also referred to as reflective polarizers, may be any reflective polarizer elements that substantially reflect light of a first polarization and substantially transmit light of another polarization. In some exemplary embodiments, reflective polarizing layers may comprise a multilayer optical film reflective polarizer which, in general, relies on the difference between refractive indices of at least two different materials, usually polymeric materials, to reflect light of a first polarization state and transmit light of a second polarization state orthogonal to the first polarization state. The at least two different materials may form alternating layers or they may form a continuous phase and a disperse phase disposed within the continuous phase. At least one of the at least two different materials may be birefringent. The reflective polarizer may be or comprise, for example, any of the Dual Brightness Enhancement Film (DBEF) products or any of the Diffusely Reflective Polarizing Film (DRPF) products, both available from 3M Company, St. Paul, Minn. under the Vikuiti™ brand. For a detailed description of the materials, properties, manufacturing, and use of reflective polarizers, See for example U.S. Pat. Nos. 5,882,774; 6,057,961; 6,080,467; 6,111,696; 6,297,906; 6,368,699; 6,627,300; 6,760,157; 6,827,886; 5,825,543; 5,867,316; 5,751,388; 5,540,978; 6,939,499; 6,949,212; or 6,936,209; or U.S. Patent Application Publication No. 2005/0024558; the disclosures of which are incorporated herein by reference. Other types of reflective polarizers are also within the scope of the present disclosure.

At least one of the polymeric layers described above comprises a polymer having naphthalate functionality obtained by polymerizing one or more monomers comprising naphthalate functionality. Examples of such monomers include naphthalates such as 2,6-, 1,4-, 1,5-, 2,7-, and 2,3-naphthalene dicarboxylic acid, and esters thereof. Monomers comprising naphthalate functionality may be used to form polyesters by polymerizing the monomers with diols such as alkane glycols and cycloalkane glycols. In one embodiment, at least one polymeric layers comprises poly(ethylene) naphthalate (PEN), which is a copolymer of 2,6-, 1,4-, 1,5-, 2,7-, and/or 2,3-naphthalene dicarboxylic acid and ethylene glycol.

In another embodiment, one of the polymeric layers comprises poly(ethylene) naphthalate, and the other polymeric layer comprises naphthalate and terephthalate functionality. Monomers having terephthalate functionality include terephthalic acid and esters thereof. In another embodiment, one polymeric layer comprises PEN, and the other polymeric layer comprises a copolymer of 2,6-, 1,4-, 1,5-, 2,7-, or 2,3-naphthalene dicarboxylic acid; terephthalic acid; and ethylene glycol. This copolymer is often referred to as coPEN.

Examples of combinations of alternating polymeric layers include PEN/coPEN, PET/coPEN, PEN/sPS, PET/sPS, PEN/Estar, PET/Estar, PET/Ecdel, PEN/Ecdel, PEN/THV, and PEN/co-PET; wherein PET is polyethylene terephthalate; sPS is syndiodactic polystryrene; Estar is polycyclohexanedimethylene terephthalate (from Eastman Chemical Co.); Ecdel is a thermoplastic polyester (from Eastman Chemical Co.); THV is a fluoropolymer (from 3M Co.); and co-PET refers to a copolymer or blend based upon terephthalic acid.

Additional layers may be present in the multilayer optical film reflective polarizer described above. For example, skin layers may be co-extruded on outer surfaces of the alternating polymeric layers in order to protect it from high shearing forces during the extrusion process. At least one support layer comprising a film, foil, semi-rigid or rigid substrate may be extruded, coated, or articled onto the multilayer optical film reflective polarizer. Examples of useful support layers include polycarbonate, polyester, acrylic, metal, or glass. In one embodiment, the support layers comprise a polycarbonate or a polyester. Adhesives may be employed in order to adhere the at least one or more support layers to the multilayer optical film reflective polarizer.

The reflective polarizer layer may be subjected to various treatments which modify the surfaces, or any portion thereof, as by rendering them more conducive to subsequent treatments such as coating, dying, metallizing, or lamination. This may be accomplished through treatment with primers, such as polyvinylvinylidene chloride, polymethylmethacrylate, epoxies, and aziridines, or through physical priming treatments such as corona, flame, plasma, flash lamp, sputter-etching, e-beam treatments, or amorphizing the surface layer to remove crystallinity, such as with a hot can.

Useful reflective polarizing layers also include wire grid polarizers as described in U.S. Pat. No. 6,122,103. Wire grid polarizers are commercially available from, inter alia, Moxtek Inc., Orem, Utah. Yet another type of reflective polarizing layer includes cholesteric polarizers as described in, for example, U.S. Pat. Nos. 5,793,456, and 6,917,399.

The optical article may further comprise an additional layer disposed on the reflective polarizing layer opposite to the adhesive layer. An additional layer may be used to provide protection from handling, e.g. scratching, or additional support. An additional layer may also be used to provide an optical function, i.e., a light management layer that changes the angular distribution or polarization component of light.

Light Diffusing Layer

The light diffusing layer may comprise one or more polymeric layers. Examples of polymers useful in the one or more polymeric layers include poly(meth)acrylics, poly(meth)acrylates, polycarbonates, polyurethanes, polyesters, polyolefins, polystyrenes, polycyclo-olefins, epoxy polymers, polyamides, polyimides, polysulfones, poly(vinyl chlorides), polysiloxanes, or silicone polymers, or copolymers or blends thereof. Examples include acrylic copolymers; polymethylmethacrylate; an acrylonitrile butadiene styrene copolymer; a styrene acrylonitrile copolymer, poly(vinylcyclohexane); polymethyl methacrylate/poly(vinylfluoride) blends; poly(ethylene); poly(propylene); PET; PEN; a poly(phenylene oxide) blend; a styrenic block copolymer; a polycarbonate/PET blend; a vinyl acetate/polyethylene copolymer; a cellulose acetate; a fluoropolymer; a poly(styrene)-poly(ethylene) copolymer, or copolymers or blends thereof. In one embodiment, the polymeric layer comprises an acrylic sheet having the ACRYLITE® brand (from Cyro Industries, Rockaway, N.J.). In another embodiment, the polymeric layer comprises polymethylmethacrylate or a copolymer of methyl methacrylate and styrene.

The light diffusing layer may comprise one or more inorganic materials such as float glass, high-quality LCD glass, and/or borosilicate.

The light diffusing layer may comprise organic, inorganic, or hybrid organic/inorganic particles or beads, or combinations thereof that are useful for diffusing light. The particles may be solid, porous, or hollow, and they may be in the form of beads, shells, spheres, or clusters. The particles may be transparent. Examples of useful particles include polystyrene beads, polymethyl methylacrylate beads, polysiloxane beads, or combinations thereof. Other examples include titanium dioxide (TiO₂), calcium carbonate (CaCO₃), barium sulphate (BaSO₄), magnesium sulphate (MgSO₄), and the like. The light diffusing layer may comprise voids or bubbles that may or may not be filled with a gas such as air or carbon dioxide. The light diffusing layers may be made diffuse by surface treatment such as roughening.

Examples of light diffusing layers are described in, for example, U.S. Pat. No. 6,723,772; International Publication No. WO 2003/064526; and International Publication No. WO 2004/111692; the disclosures of which are incorporated herein by reference.

The properties of the light diffusing layer may be tailored to provide particular optical and physical performance features depending on the application. For example, the light diffusing layer may be designed to exhibit a particular light transmission characteristic. For light diffusing layers having more than one layer, one may design the optical and physical properties of each of the layers separately. Physical properties of the light diffusing layer may be adjusted by the choice of the polymeric material. The thickness of the layers, and the particular choice of particles, such as their size, shape, and amount, may be varied in order to adjust optical properties. In an exemplary embodiment, the light diffusing layer is a diffuser plate.

Additional components may be added to any one of the layers of the optical article. Examples include UV absorbers such as benzotriazoles, benzatriazines, and benzophenones, or combinations thereof. Light stabilizers such as hindered amine light stabilizers may also be added, and also heat stabilizers, optical brighteners, antistat materials, and phosphors. See for example U.S. Pat. Nos. 6,723,772 and 6,613,619, which are incorporated herein by reference.

Adhesive Layer

The optical article comprises an adhesive layer disposed between the reflective polarizing layer and the light diffusing layer, wherein the adhesive layer bonds the reflective polarizing layer and the light diffusing layer together. In one embodiment, the adhesive layer comprises a pressure sensitive adhesive. In this regard, a pressure-sensitive adhesive refers to a viscoelastic material that displays aggressive tackiness and adheres well to a wide variety of substrates after applying only light pressure (e.g. finger pressure). An acceptable quantitative description of a pressure sensitive adhesive is given by the Dahlquist criterion, which indicates that materials having a storage modulus (G′) of less than about 4.0×10⁵ Pascals (measured at room temperature) have pressure sensitive adhesive properties.

In another embodiment, the adhesive layer comprises a blend of: a majority of a soft pressure sensitive adhesive polymer having acid or base functionality, a high Tg polymer having a glass transition temperature (Tg) of greater than about 20° C. and having acid or base functionality, and a crosslinker; wherein the functionality of the soft pressure sensitive adhesive polymer and the functionality of the high Tg polymer form an acid-base interaction when mixed. “Tg” means the temperature at which a polymer transitions from a glassy to a rubbery state, as can be measured by differential scanning calorimetry.

The soft pressure sensitive adhesive polymer may comprise a copolymer of one or more acrylate or methacrylate monomers, collectively refered to as (meth)acrylate monomers, that have the formula: 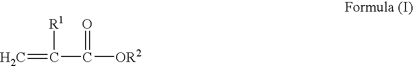
wherein R¹ is H or CH₃; and R² is a linear, branched, aromatic, or cyclic hydrocarbon group, for example, an alkyl group comprising from about 1 to about 20 carbon atoms. R² may also include heteroatoms such as nitrogen, oxygen or sulfur.

Examples of suitable (meth)acrylate monomers include benzyl methacrylate, n-butyl acrylate, n-butyl methacrylate, cyclohexyl acrylate, cyclohexyl methacrylate, decyl acrylate, 2-ethoxy ethyl acrylate, 2-ethoxy ethyl methacrylate, ethyl acrylate, 2-ethylhexyl acrylate, ethyl methacrylate, n-hexadecyl acrylate, n-hexadecyl methacrylate, hexyl acrylate, hydroxy-ethyl methacrylate, hydroxy ethyl acrylate, isoamyl acrylate, isobornyl acrylate, isobornyl methacrylate, isobutyl acrylate, isodecyl acrylate, isodecyl methacrylate, isononyl acrylate, isooctyl acrylate, isooctyl methacrylate, isotridecyl acrylate, lauryl acrylate, lauryl methacrylate, 2-methoxy ethyl acrylate, methyl acrylate, methyl methacrylate, 2-methyl butyl acrylate, 4-methyl-2-pentyl acrylate, 1-methylcyclohexyl methacrylate, 2-methylcyclohexyl methacrylate, 3-methylcyclohexyl methacrylate, 4-methylcyclohexyl methacrylate, octadecyl acrylate, octadecyl methacrylate, n-octyl acrylate, n-octyl methacrylate, 2-phenoxy ethyl methacrylate, 2-phenoxy ethyl acrylate, propyl acrylate, propyl methacrylate, n-tetradecyl acrylate, n-tetradecyl methacrylate, and mixtures thereof.

In one embodiment, R² is a linear, branched, aromatic, or cyclic hydrocarbon group comprising from about 4 to about 12 carbon atoms. Examples include n-butyl acrylate, 2-ethylhexyl acrylate, isooctyl acrylate, isononyl acrylate, isodecyl acrylate, lauryl acrylate, and mixtures thereof.

The soft pressure sensitive adhesive polymer may comprise a (meth)acrylate monomer that, as a homopolymer, has a Tg of less than about 0° C.; and a reinforcing monomer that, as a homopolymer, has a Tg of at least about 20° C. The soft pressure sensitive adhesive polymer may comprise a (meth)acrylate monomer that, as a homopolymer, has a Tg of less than about −20° C.; and the reinforcing monomer that, as a homopolymer, has a Tg of at least about 50° C.

The soft pressure sensitive adhesive polymer may comprise the (meth)acrylate monomer in an amount of from about 40% by weight to about 98% by weight.

The soft pressure sensitive adhesive polymer may comprise the reinforcing monomer in an amount of up to about 20% by weight, or up to about 10% by weight. These reinforcing monomers can contain acidic or basic functionalities.

The soft pressure sensitive adhesive polymer comprises acid or base functionality which may be obtained by randomly polymerizing acidic or basic monomers, respectively. In either case, the soft pressure sensitive adhesive polymer may comprise additional neutral monomers, referred to as non-acidic and non-basic monomers, respectively.

Acid functionality may be incorporated into the soft pressure sensitive adhesive polymer by copolymerizing acidic monomers such as ethylenically unsaturated carboxylic acids, ethylenically unsaturated sulfonic acids, ethylenically unsaturated phosphonic acids, and mixtures thereof. Ethylenically unsaturated carboxylic acids are useful because they are readily available. Sulfonic and phosphonic acid derivatives provide a strong interaction with basic functionality, which is useful when high cohesive strength, temperature resistance, and solvent resistance are desired. Particularly suitable acidic monomers are acidic (meth)acrylates. Examples of acidic monomers are (meth)acrylic acid, itaconic acid, fumaric acid, crotonic acid, citraconic acid, maleic acid, oleic acid, B-carboxyethyl acrylate, 2-sulfoethyl methacrylate, styrene sulfonic acid, 2-acrylamido-2-methylpropane sulfonic acid, vinyl phosphonic acid, and mixtures thereof.

When the soft pressure sensitive adhesive polymer comprises acid functionality, the acidic monomers described above may be polymerized with non-acidic monomers. The amount of acid and non-acidic monomers may vary, and may depend on the desired properties of the soft pressure sensitive adhesive polymer, such as its cohesive strength. For example, acidic monomers may comprise from about 2% by weight to about 30% by weight, preferably from about 2% by weight to about 15% by weight.

In one embodiment, the soft pressure sensitive adhesive polymer comprises isooctyl acrylate and acrylic acid (90/10 to 98/2 by weight), prepared using methods described in U.S. Pat. No. 4,074,004.

Basic functionality may be incorporated into the soft pressure sensitive adhesive polymer by copolymerizing (meth)acrylate monomers with basic monomers that have Formula (II):

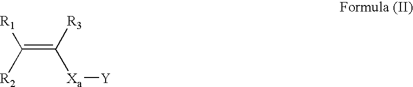

wherein
a is 0 or 1;
R₁, R₂, and R₃ are independently selected from H— and CH₃— or other alkyl group,
X is selected from an ester or amide group; and
Y is an alkyl group, a nitrogen-containing aromatic group, or a nitrogen-containing group such as

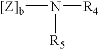

wherein
Z is a divalent linking group (typically from about 1 to 5 carbon atoms);
b is 0 or 1; and
R₄ and R₅ are selected from hydrogen, alkyl, aryl, cycloalkyl, and arenyl groups.

R₄ and R₅ in the above group may also form a heterocycle. In all embodiments, Y, R₁, and R₂ may also comprise heteroatoms, such as O, S, N, etc. While Formula II summarizes the majority of basic monomers useful in the present invention, other nitrogen-containing monomers are possible if they meet the definition of a basic monomer (i.e., can be titrated with an acid).

Exemplary basic monomers include N,N-dimethylaminopropyl methacrylamide (DMAPMAm); N,N-diethylaminopropyl methacrylamide (DEAPMAm); N,N-dimethylaminoethyl acrylate (DMAEA); N,N-diethylaminoethyl acrylate (DEAEA); N,N-dimethylaminopropyl acrylate (DMAPA); N,N-diethylaminopropyl acrylate (DEAPA); N,N-dimethylaminoethyl methacrylate (DMAEMA); N,N-diethylaminoethyl methacrylate (DEAEMA); N,N-dimethylaminoethyl acrylamide (DMAEAm); N,N-dimethylaminoethyl methacrylamide (DMAEMAm); N,N-diethylaminoethyl acrylamide (DEAEAm); N,N-diethylaminoethyl methacrylamide (DEAEMAm); N,N-dimethylaminoethyl vinyl ether (DMAEVE); N,N-diethylaminoethyl vinyl ether (DEAEVE); and mixtures thereof. Other useful basic monomers include vinylpyridine, vinylimidazole, tertiary amino-functionalized styrene (e.g., 4-(N,N-dimethylamino)-styrene (DMAS), 4-(N,N-diethylamino)-styrene (DEAS)), N-vinyl pyrrolidone, N-vinyl caprolactam, acrylonitrile, N-vinyl formamide, (meth)acrylamide, and mixtures thereof.

When the soft pressure sensitive adhesive polymer comprises basic functionality, the basic monomers described above may be polymerized with non-basic monomers. The amount of basic and non-basic monomers may vary, and may depend on the desired properties of the soft pressure sensitive adhesive polymer, such as its cohesive strength. For example, basic monomers may comprise from about 2% by weight to about 50% by weight, preferably from about 5% by weight to about 30% by weight.

In one embodiment, the soft pressure sensitive adhesive polymer comprises isooctyl acrylate and acrylamide (93:7) prepared using the methods described in U.S. Pat. No. 4,751,087.

The adhesive layer comprises a high Tg polymer having an acid or base functionality. The high Tg polymer may comprise any of the monomers described above, such as the monomers of Formulas (I) and (II), the alkyl (meth)acrylate monomers comprising an alkyl group, vinyl esters, styrenes, halides, polyethers, macromers, and mixtures thereof. Useful monomers particularly include those that, as homopolymers, have Tg values of greater than about 20° C.

Examples of monomers useful in the high Tg polymer include t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, benzyl methacrylate, bromoethyl methacrylate, 2-hydroxyethyl methacrylate, hydroxypropyl methacrylate, glycidyl methacrylate, alkyl methacrylate, styrene, vinyl acetate, and vinyl chloride.

In one embodiment, the combination of monomers should be chosen such that the Tg of the high Tg polymer is greater than that of the soft pressure sensitive adhesive polymer, preferably greater than about 20° C. In other embodiments, the Tg of the high Tg polymer is greater than about 40° C., 50° C., or 60° C. The monomers having a Tg of greater than about 20° C. (the high Tg polymers) may be present in an amount of at least about 70% by weight, at least about 85% by weight, or at least about 90% by weight.

In an exemplary embodiment, the high Tg polymer may comprise acid or base functionality as described above for the soft pressure sensitive adhesive polymer. Any of the acidic or basic monomers described above may be used, and they may be polymerized with non-acidic and non-basic monomers, respectively, as described above for the soft pressure sensitive adhesive polymer. When used, the acidic and basic monomers may comprise from about 2% by weight to about 30% by weight, preferably from about 2% by weight to about 15% by weight. When used, the basic monomers may comprise from about 2% by weight to about 50% by weight, preferably from about 5% by weight to about 30% by weight.

The acid and base functionalities for the soft pressure sensitive adhesive polymer and the high Tg polymer are selected such that they form an acid-base interaction when mixed. For example, if the soft pressure sensitive adhesive polymer comprises an acid functionality, then the high Tg polymer comprises basic functionality.

The adhesive layer comprises a crosslinker in order to provide cohesive strength of the layer. The crosslinker may be a thermal crosslinker such as a multifunctional aziridine, an isocyanate, or an epoxy. One example is 1,1′-(1,3-phenylene dicarbonyl)-bis-(2-methylaziridine). The crosslinker may also be a chemical crosslinker such as a peroxide, e.g., benzoyl peroxide. The crosslinker may also be a photosensitive crosslinker which is activated by high intensity ultraviolet light, e.g., benzophenone and copolymerizable aromatic ketone monomers as described in U.S. Pat. No. 4,737,559, or triazines, e.g., 2,4-bis(trichloromethyl)-6-(4-methoxy-pheynl)-s-triazine. The crosslinker may also be hydrolyzable, such as monoethylenic ally unsaturated mono-, di-, and trialkoxy silane compounds including, but not limited to, methacryloxypropyltrimethoxysilane (available from Gelest, Inc., Tullytown, Pa.), vinyldimethylethoxysilane, vinylmethyl diethoxysilane, vinyltriethoxysilane, vinyltrimethoxysilane, and vinyltriphenoxysilane. Other suitable crosslinkers include those described in commonly owned U.S. Pat. No. 6,369,123, entitled “Radiation-crosslinkable elastomers and photocrosslinkers therefore,” and U.S. Pat. No. 5,407,971, entitled “Radiation crosslinked elastomers,” hereby incorporated by reference. Crosslinking may also be achieved using high energy electromagnetic radiation such as gamma or e-beam radiation.

The particular choice and amount of crosslinker used in the blend may depend on the other polymers present in the blend, as well as the other layers in the optical article, and the application in which the optical article is used. Typically, the crosslinker is present in amounts of less than about 5 parts based on the total dry weight of the blend, and more specifically, from about 0.01 parts to 1 part.

The soft pressure sensitive adhesive polymer and the high Tg polymer may be prepared by any conventional free radical polymerization method, including solution, radiation, bulk, dispersion, emulsion, and suspension processes. The adhesive may comprise additives such as tackifiers, plasticizers, UV absorbers, free radical initiators or photoinitiators, or chain transfer agents, etc. Details of these processes and additives may be found in, for example, International Publication No. WO 97/23577.

The dry thickness of the adhesive layer may be from about 0.05 micrometers to about 100 micrometers.

The soft pressure sensitive adhesive polymer and the high Tg polymer are compatibilized using a compatibilization scheme which is independent of the particular functionality of each polymer. When compatible, the polymers form a stable multiphase morphology wherein the phases do not significantly coalesce and/or increase in size upon aging at high temperatures or above the Tg of the materials. The compatibilization scheme describes the method by which the soft pressure sensitive adhesive polymer and the high Tg polymer are made to be compatible with one another due to their interfacial interactions.

In an exemplary embodiment, the compatibilization scheme comprises functionalizing the soft pressure sensitive adhesive polymer and the high Tg polymer in such a way that an acid-base interaction is present between the two polymers. The acid-base interaction may be described as a Lewis acid-base interaction. Lewis acid-base interactions require that one chemical component be an electron acceptor (acid) and the other an electron donor (base). The electron donor provides an unshared pair of electrons and the electron acceptor provides an orbital system that can accommodate the unshared pair of electrons. The following general equation describes the Lewis acid-base interaction:
A (acid)+:B (base)→A:B (acid-base complex)

The acid-base interaction between the polymers may reduce their interfacial tension leading to a reduction in the particle size of a dispersed phase, a reduction in the domain size of the high Tg polymer, and stabilization of a multiphase morphology. The domain size of the high Tg polymer dispersed within the soft pressure sensitive adhesive polymer is less than the wavelength of light for the blend to be optically clear.

The relative amounts of the soft pressure sensitive adhesive polymer and the high Tg polymer present in the blend may depend on factors such as the chemical identities and molecular weights of each polymer, amount of crosslinker present in the blend, and the desired properties of the adhesive layer as described below. Relative to the total weight of the soft pressure sensitive adhesive polymer and the high Tg polymer, the amount of high Tg polymer may be from about 5% by weight to about 50% by weight, or from about 10% by weight to about 30% by weight.

The adhesive layer may comprise a blend of a majority of a soft pressure sensitive adhesive polymer having acid or base functionality and a high Tg polymer having acid or base functionality, and a crosslinker; wherein the functionality of the soft pressure sensitive adhesive polymer and the functionality of the high Tg polymer form an acid-base interaction when mixed. The soft pressure sensitive adhesive polymer and the high Tg polymer may be incorporated into the blend using traditional methods such as by mixing them in solution, mechanical rolling, and hot melt blending, for example.

The blend may be applied to the reflective polarizing layer or the light diffusing layer using conventional coating methods such as gravure coating, curtain coating, slot coating, spin coating, screen coating, transfer coating, brush coating, or roller coating, for example. The blend may also be hot-melt coated. For most coating methods, the blend may additionally comprise a solvent which may be removed after the coating operation. The % solids of the blend may vary depending on the coating method and the particular chemical identities of the soft pressure sensitive adhesive polymer, the high Tg polymer, and the crosslinker. The blend may also be coated onto a release liner such as paper and film liners coated with release agents such as silicones or fluorocarbons, for example. An example is the T-30 liner available from CP Film, Martinsville, Va. The release liner may then be removed. Whether applied directly to the reflective polarizing layer, the light diffusing layer, or a release liner, the remaining layers of the optical article may then be laminated to the adhesive layer.

In an exemplary embodiment, the adhesive layer is optically clear as measured by visual observation or measurement according to ASTM-D 1003-95. When measured, an exemplary embodiment of the adhesive layer has a transmission of at least about 90% and haze of less than about 2%. It is desirable that the adhesive layer remain optically clear over the useful life of the optical article. In an exemplary embodiment, the adhesive layer also maintains bond strength, integrity, and stability and does not exhibit delamination or bubbling over time and under a variety of environmental conditions, as may be estimated using accelerated aging tests.

In one example, the soft pressure sensitive adhesive polymer may comprise a polyurethane, a polyolefin, a tackified natural rubber, a synthetic rubber, a tackified styrene block copolymer, a polyvinyl ether, or a combination thereof. The soft pressure sensitive adhesive polymer may comprise a copolymer of one or more vinyl esters (e.g., vinyl acetate), styrene, substituted styrene (e.g., a-methyl styrene), vinyl halide, vinyl propionate, and mixtures thereof. Other useful vinyl monomers include macromeric (meth)acrylates such as (meth)acrylate-terminated styrene oligomers and (meth)acrylate-terminated polyethers, such as are described in International Publication No. WO 84/03837 and European Patent No. EP 140941. The soft pressure sensitive adhesive polymer may be a waterborne emulsion or dispersion.

The adhesive layer may comprise a heat-activated adhesive or a UV-curable adhesive as described in U.S. Patent Application Publication No. 2006/0029784, the disclosure of which is herein incorporated by reference.

Display Devices

Disclosed herein is a display device comprising, in an exemplary embodiment, a display panel, a light source, and any one of the optical articles described above and which is disposed between the display panel and the light source. In one embodiment, the display device is a direct-lit display device. For a detailed description of the design, applications, materials, properties, manufacturing and use of direct-lit display devices, see for example, any of the previously cited references which are incorporated herein by reference, or any of the following references, which are also incorporated herein by reference: U.S. patent application Ser. No. 10/966,610; U.S. Pat. No. 6,744,561B2; and U.S. Patent Application Publication No. 2004/0228141.

A schematic exploded view of an exemplary embodiment of a direct-lit LC display device 20 is presented in FIG. 2. Such a display device 20 may be used, for example, in an LCD monitor or LCD-TV. The display device 20 is based on the use of an LC panel 22, which typically comprises LC layer 24 disposed between panel plates 26. The plates 26 are often formed of glass, and may include electrode structures and alignment layers on their inner surfaces for controlling the orientation of the liquid crystals in the LC layer 24. The electrode structures are commonly arranged so as to define LC panel pixels, areas of the LC layer where the orientation of the liquid crystals can be controlled independently of adjacent areas. A color filter may also be included with one or more of the plates 106 for imposing color on the image displayed.

An upper absorbing polarizer 28 may be positioned above the LC layer 24 and a lower absorbing polarizer 30 may be positioned below the LC layer 24. In the illustrated embodiment, the upper and lower absorbing polarizers 28, 30 are located outside the LC panel 22. In this exemplary embodiment, the absorbing polarizers 28, 30 and the LC panel 22 in combination control the transmission of light from the backlight 32 through the display 20 to the viewer. In some LC displays, the absorbing polarizers 28, 30 may be arranged with their transmission axes perpendicular. When a pixel of the LC layer 24 is not activated, it may not change the polarization of light passing therethrough. Accordingly, light that passes through the lower absorbing polarizer 30 is absorbed by the upper absorbing polarizer 28, when the absorbing polarizers 28, 30 are aligned perpendicularly.

When the pixel is activated, on the other hand, the polarization of the light passing therethrough is rotated, so that at least some of the light that is transmitted through the lower absorbing polarizer 30 is also transmitted through the upper absorbing polarizer 28. Selective activation of the different pixels of the LC layer 24, for example by a controller 34, results in the light passing out of the display at certain desired locations, thus forming an image seen by the viewer. The controller 34 may include, for example, a computer or a television controller that receives and displays television images. One or more optional layers 36 may be provided over the upper absorbing polarizer 28, for example to provide mechanical and/or environmental protection to the display surface. In one exemplary embodiment, the layer 36 may include a hardcoat over the absorbing polarizer 28 or another suitable additional layer.

It will be appreciated that some type of LC displays may operate in a manner different from that described above. For example, the absorbing polarizers may be aligned parallel and the LC panel may rotate the polarization of the light when in an unactivated state. Regardless, the basic structure of such displays remains similar to that described above or as otherwise known to those of ordinary skill in the art.

The backlight 32 includes one or more, and, typically, a number of light sources 38 that generate the light that illuminates the LC panel 22. The light sources 38 used in a LCD-TV or LCD monitor are often linear, cold cathode, fluorescent tubes that extend across the display device 20. Other types of light sources may be used, however, such as filament or arc lamps, light emitting diodes (LEDs), flat fluorescent panels or external fluorescent lamps. This list of light sources is not intended to be limiting or exhaustive, but only exemplary.

The backlight 32 may also include a reflector 40 for reflecting light propagating downwards from the light sources 38, in a direction away from the LC panel 22. The reflector 40 may also be useful for recycling light within the display device 20, as is explained below. The reflector 40 may be a specular reflector or may be a diffuse reflector. One example of a specular reflector that may be used as the reflector 40 is Vikuiti™ Enhanced Specular Reflection (ESR) film available from 3M Company, St. Paul, Minn. Examples of suitable diffuse reflectors include polymers, such as polyethylene terephthalate (PET), polycarbonate (PC), polypropylene, polystyrene and the like, loaded with diffusely reflective particles, such as titanium dioxide, barium sulphate, calcium carbonate and the like. Other examples of diffuse reflectors, including microporous materials and fibril-containing materials, are discussed in co-owned U.S. Pat. No. 6,780,355, incorporated herein by reference.

An arrangement of light management layers 42 is positioned between the backlight 32 and the LC panel 22 in order to affect light propagating from backlight 32 and improve operation of display device 20. The arrangement includes any one of the optical articles described above and comprises reflective polarizing layer 12; light diffusing layer 14; and adhesive layer 16 disposed between the reflective polarizing layer 12 and the light diffusing layer 14, wherein the adhesive layer 16 bonds the reflective polarizing layer 12 and the light diffusing layer 14 together.

The light sources 38 typically produce unpolarized light but the lower absorbing polarizer 30 only transmits a single polarization state, and so about half of the light generated by the light sources 38 is not transmitted through to the LC layer 24. The reflective polarizing layer 12 reflects the light that would otherwise be absorbed in the lower absorbing polarizer, and so this light may be recycled by reflection between the reflective polarizing layer 12 and the reflector 40. At least some of the light reflected by the reflective polarizing layer 12 may be depolarized, and subsequently returned to the reflective polarizing layer 12 in a polarization state that is transmitted through the reflective polarizing layer 12 and the lower absorbing polarizer 30 to the LC layer 24. In this manner, the reflective polarizing layer 12 may be used to increase the fraction of light emitted by the light sources 38 that reaches the LC layer 24, and so the image produced by the display device 20 is brighter.

As described above, the diffusing layer 14 diffuses light received from the light sources, which results in an increase in the uniformity of the illumination light incident on the LC panel 22. Consequently, this results in an image perceived by the viewer that is more uniformly bright.

In some exemplary embodiments, the arrangement of light management layers 42 also includes a brightness enhancing layer 44. A brightness enhancing layer 44 is a structured surface layer e.g., one that includes a surface structure that redirects off-axis light in a direction closer to the axis of the display. This increases the amount of light propagating on-axis through the LC layer 24, thus increasing the brightness of the image seen by the viewer. One example is a prismatic brightness enhancing layer, which has a number of prismatic ridges that redirect the illumination light, through refraction and reflection, but other structured layers are also within the scope of the present disclosure. Examples of prismatic brightness enhancing layers that may be used in the display device include the Vikuiti™ BEFII and BEFIII family of prismatic films available from 3M Company, St. Paul, Minn., including BEFII 90/24, BEFII 90/50, BEFIIIM 90/50, and BEFIIIT.

### EXAMPLES

Preparation of Optical Articles

### Example 1

3M™ Vikuiti™ Dual Brightness Enhancement Film (DBEF-Q) was used as the reflective polarizing layer. The light diffusing layer was a clear sheet (48.8 cm×27.4 cm) having 3.6 mm thickness and comprising a copolymer of methyl methacrylate and styrene (hereinafter referred to as MS; from CYRO Industries, Rockaway, N.J.). The adhesive was a blend of 90% of a pressure sensitive adhesive, a copolymer of isooctylacrylate and acrylic acid (93:7), and 10% of a high Tg polymer, a copolymer of methylmethacrylate, butylmethacrylate, and DMA-EMA (69:25:6) and having a Mw˜140,000 g/mol. The adhesive layer was formed on a release liner by coating a solvent-based composition of 20% wt. % solids in ethyl acetate, methyl ethyl ketone, and methanol, followed by drying at 60° C. for 20 minutes. The resulting thickness of the adhesive layer was 27.4 microns. The adhesive layer is hereinafter referred to as Adhesive A. The reflective polarizer, the adhesive layer, and the light diffusing layer were laminated together at room temperature using conventional film to plate techniques.

### Example 2

Example 2 was prepared as in Example 1 except that the light diffusing layer was a 2.0 mm clear polycarbonate (PC) sheet supplied by Sheffield Plastics, Inc., Sheffield, Mass.

### Example 3

Example 3 was prepared as in Example 1 except that the light diffusing layer was a 2.5 mm clear polymethylmethacrylate (PMMA) sheet supplied by CYRO Industries, Rockaway, N.J.

### Example 4

Example 4 was prepared as in Example 1 except that Soken FP-7 adhesive from Soken Chemical and Engineering Co., Ltd., Tokyo, Japan was used.

### Example 5

Example 5 was prepared as in Example 2 except that Soken FP-7 adhesive from Soken Chemical and Engineering Co., Ltd., Tokyo, Japan was used.

### Example 6

Example 6 was prepared as in Example 3 except that Soken FP-7 adhesive from Soken Chemical and Engineering Co., Ltd., Tokyo, Japan was used.

### Example 7

Example 7 was prepared as in Example 1 except that the light diffusing layer was a 2.0 mm diffuse MS sheet supplied by CYRO Industries, Rockaway, N.J.

### Comparative Example 1

Comparative Example 1 was prepared as in Example 3 except that 3M 9483 adhesive from 3M Co. (76.2-micron acrylic pressure sensitive adhesive) was used.

### Comparative Example 2

Comparative Example 2 was prepared as in Example 3 except that 3M 8142 adhesive from 3M Co. (50-micron acrylic pressure sensitive adhesive) was used.

### Comparative Example 3

Comparative Example 3 was prepared as in Example 1 except that Soken 1885 adhesive from Soken Chemical and Engineering Co., Ltd., Tokyo, Japan was used.

### Comparative Example 4

Comparative Example 4 was prepared as in Example 2 except that Soken 1885 adhesive from Soken Chemical and Engineering Co., Ltd., Tokyo, Japan was used.

### Comparative Example 5

Comparative Example 5 was prepared as in Example 3 except that Soken 1885 adhesive from Soken Chemical and Engineering Co., Ltd., Tokyo, Japan was used.

### Comparative Example 6

Comparative Example 6 was prepared as in Example 7 except that 3M 9483 adhesive from 3M Co. (76.2 μm) was used.

A summary of the optical articles described above is provided in Table 1.

TABLE 1

| | | | Adhesive | | Substrate |
|---|---|---|---|---|---|
| Sample | Optical Film | Adhesive | Thickness (μm) | Substrate | Thickness (mm) |
| Example 1 | DBEF-Q | Adhesive A | 27.4 | MS | 3.6 |
| Example 2 | DBEF-Q | Adhesive A | 27.4 | PC | 2.0 |
| Example 3 | DBEF-Q | Adhesive A | 27.4 | PMMA | 2.5 |
| Example 4 | DBEF-Q | Soken FP-7 | 25.4 | MS | 3.6 |
| Example 5 | DBEF-Q | Soken FP-7 | 25.4 | PC | 2.0 |
| Example 6 | DBEF-Q | Soken FP-7 | 25.4 | PMMA | 2.5 |
| Example 7 | DBEF-Q | Adhesive A | 27.4 | MS | 2.0 |
| Comp. Example 1 | DBEF-Q | 3M 9483 | 76.2 | PMMA | 2.5 |
| Comp. Example 2 | DBEF-Q | 3M 8142 | 50.8 | PMMA | 2.5 |
| Comp. Example 3 | DBEF-Q | Soken 1885 | 25.4 | MS | 3.6 |
| Comp. Example 4 | DBEF-Q | Soken 1885 | 25.4 | PC | 2.0 |
| Comp. Example 5 | DBEF-Q | Soken 1885 | 25.4 | PMMA | 2.5 |
| Comp. Example 6 | DBEF-Q | 3M 9483 | 76.2 | MS | 2.0 |

Accelerated Aging Protocol

Accelerated aging protocols were used for testing the aging properties of the optical articles. One protocol, high temperature, was carried out by placing the article in an 85° C. oven for 500 hours. Another protocol, high temperature with humidity, was carried out by placing the article in an oven at 65° C. and 95% relative humidity for 500 hours. All samples used in the high temperature protocol and the high temperature with humidity protocol were 48.8 cm×27.4 cm. The final protocol, high temperature with UV radiation, was carried out by placing the article in an 80° C. oven that contained fluorescent lamps (Phillips F40 50U) for 288 hours. These samples were 12.7 cm×7.6 cm.

Visual Defect Identification

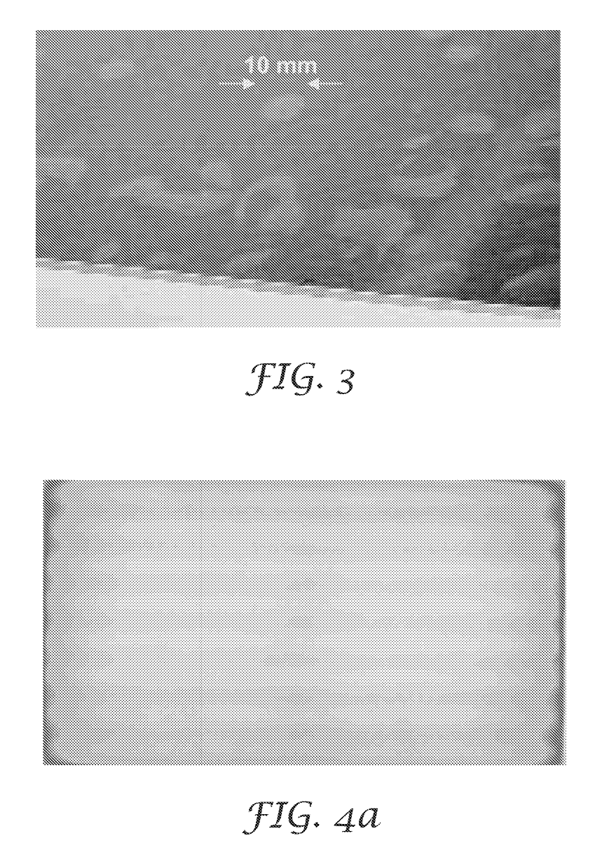

Defects in the adhesive layer of the aged articles were identified by visual inspection. Defects are defined as any visible artifact that exists on any location of the sample. Defects ranged in type from air voids in a layer to a disruption in a layer. The sizes of the defects ranged from 1 micron to 10 mm in size. Several light sources were used to help identify these defects: transmitted light, reflected light, and polarized transmitted light. If one defect was found in the 48.8 cm×27.4 cm sample, the sample was classified as Fail, and if no visible defects were present, the sample was classified as Pass. Typical defects are shown in FIG. 3. In all of the samples that failed, the defects were between 0.5 to 1 cm in size, and there were at least 5 defects per sample. The results are shown in Table 2.

TABLE 2

| Sample | Adhesive | Substrate | 85° C. | 65° C./95% RH |
|---|---|---|---|---|
| Example 1 | Adhesive A | MS | Pass | Pass |
| Example 2 | Adhesive A | PC | Pass | Pass |
| Example 3 | Adhesive A | PMMA | Pass | Pass |
| Example 4 | Soken FP 7 | MS | Pass | Pass |
| Example 5 | Soken FP 7 | PC | Pass | Pass |
| Example 6 | Soken FP 7 | PMMA | Pass | Pass |
| Comp. Example 1 | 3M 9483 | PMMA | Fail | Fail |
| Comp. Example 2 | 3M 8142 | PMMA | NT¹ | Fail |
| Comp. Example 3 | Soken 1885 | MS | Fail | Fail |
| Comp. Example 4 | Soken 1885 | PC | Fail | Fail |
| Comp. Example 5 | Soken 1885 | PMMA | Pass | Pass |

¹NT = not tested

Quantitative Defect Analysis

Optical articles of this disclosure were optically evaluated for brightness and uniformity in the LCD-TV display testbed prior to and following the accelerating aging protocols defined above. Visual defects were identified by a region of reduced brightness of the display in close proximity to the defect. FIGS. 4A and 4B show effects of aging for Comparative Example 6. FIG. 4A shows the initial appearance, and FIG. 4B shows the appearance after the 65° C. and 95% RH which is no longer fit for use in a liquid crystal display due to regions of non-uniformity created by defects in the article. The presence of defects resulted in an increase in the standard deviation of the luminance of the testbed. The results are shown in Table 3.

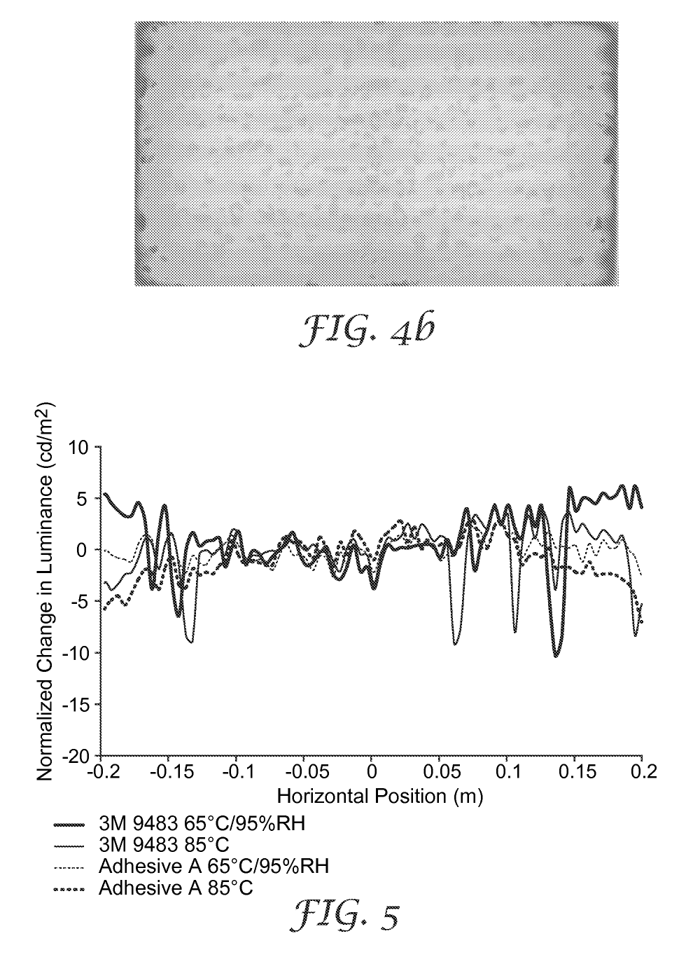

Each optical article was further compared before and after aging by subtracting the aged data from the initial data collected on the article. FIG. 5 shows the horizontal position (m) versus the normalized change in luminance (cd/m²) for Example 7 and Comparative Example 6 (cross-sections taken from the center of each of the optical articles were used). Visual defects may be identified by sharp localized decreases in brightness. The large (5-10 cd/m²) localized peaks present in the data from Comparative Example 6 indicate regions of non-uniformity which would be visually unacceptable when viewed in a liquid crystal display.

In an exemplary embodiment, the standard deviation of luminance is less than about 4.0, more preferably less than about 3.0, and even more preferably less than about 2.0 cd/m².

TABLE 3

| | | | Standard Deviation of | |
|---|---|---|---|---|
| | | | Luminance (cd/m²) | |
| | | | | Change from |
| | Aging | | | Room |
| Sample | Protocol | Adhesive | Average | Temperature |
| Example 7 | Room | Adhesive A | 1.89 | no change |
| | Temperature | | | |
| Example 7 | 65° C./95% RH | Adhesive A | 1.96 | 0.06 |
| Example 7 | 85° C. | Adhesive A | 1.95 | 0.07 |
| Comp. | Room | 3M 9483 | 1.60 | no change |
| Example 6 | Temperature | | | |
| Comp. | 65° C./95% RH | 3M 9483 | 4.73 | 3.13 |
| Example 6 | | | | |
| Comp. | 85° C. | 3M 9483 | 4.18 | 2.58 |
| Example 6 | | | | |

BYK Color Sphere Measurements

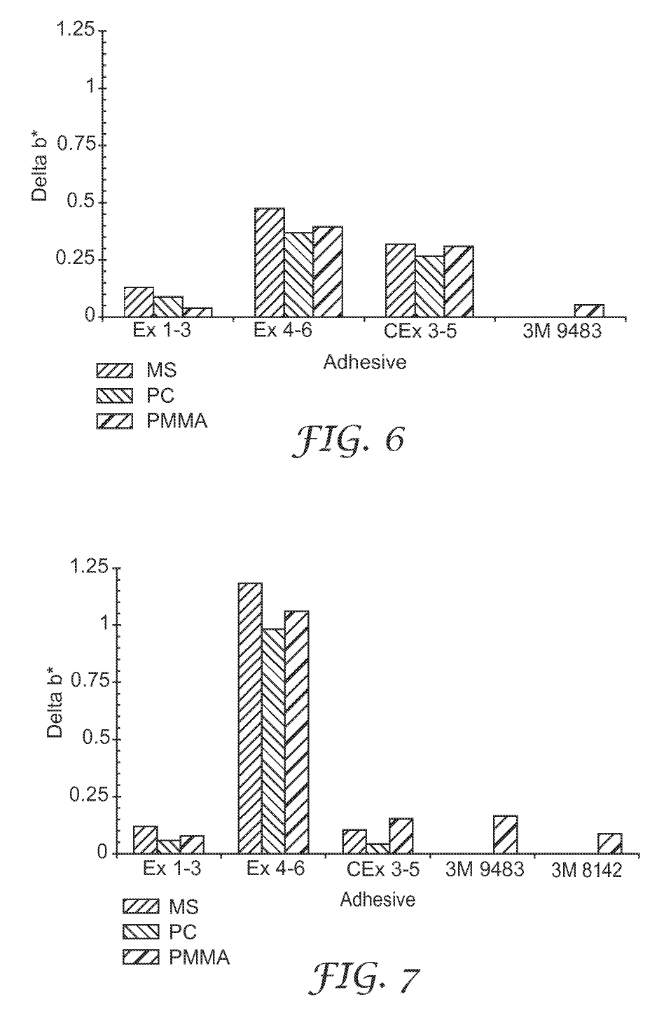

Color changes caused by accelerated aging were measured in 1976 CIE L*a*b* color space using a BYK Gardner Colorsphere (Cat. No. 6465, Serial No. 976904) as described in ASTM E1164: Obtaining Spectrometric Data for Object-Color Evaluation. The instrument was calibrated to calculate the color shift of the sample from air. Table 4 and FIG. 6 show the color change from the 500 hour 85° C. accelerated aging protocol. Table 5 and FIG. 7 show the color change from the 500 hour 65° C./95% RH accelerated aging protocol. Table 6 shows the color change from the 288 hour QUV accelerated aging protocol.

TABLE 4

| Sample | Adhesive | Substrate | Delta E* | Delta L* | Delta a* | Delta b* |
|---|---|---|---|---|---|---|
| Example 1 | Adhesive A | MS | 0.161 | −0.068 | −0.039 | 0.130 |
| Example 2 | Adhesive A | PC | 0.122 | −0.071 | −0.014 | 0.089 |
| Example 3 | Adhesive A | PMMA | 0.099 | −0.065 | −0.006 | 0.039 |
| Example 4 | Soken FP 7 | MS | 0.559 | −0.292 | −0.015 | 0.475 |
| Example 5 | Soken FP 7 | PC | 0.432 | −0.219 | −0.008 | 0.370 |
| Example 6 | Soken FP 7 | PMMA | 0.501 | −0.298 | 0.003 | 0.395 |
| Comp. Example 1 | 3M 9483 | PMMA | 0.139 | −0.122 | −0.037 | 0.053 |
| Comp. Example 2 | 3M 8142 | PMMA | NT | NT | NT | NT |
| Comp. Example 3 | Soken 1885 | MS | 0.353 | −0.123 | −0.079 | 0.318 |
| Comp. Example 4 | Soken 1885 | PC | 0.292 | −0.037 | −0.107 | 0.267 |
| Comp. Example 5 | Soken 1885 | PMMA | 0.392 | −0.234 | −0.048 | 0.309 |

1. NT = not tested

TABLE 5

| Sample | Adhesive | Substrate | Delta E* | Delta L* | Delta a* | Delta b* |
|---|---|---|---|---|---|---|
| Example 1 | Adhesive A | MS | 0.127 | −0.033 | −0.017 | 0.119 |
| Example 2 | Adhesive A | PC | 0.113 | −0.079 | 0.016 | 0.057 |
| Example 3 | Adhesive A | PMMA | 0.158 | −0.109 | −0.002 | 0.079 |
| Example 4 | Soken FP 7 | MS | 1.455 | −0.838 | 0.091 | 1.184 |
| Example 5 | Soken FP 7 | PC | 1.261 | −0.778 | 0.133 | 0.981 |
| Example 6 | Soken FP 7 | PMMA | 1.396 | −0.887 | 0.129 | 1.059 |
| Comp. Example 1 | 3M 9483 | PMMA | 0.633 | −0.577 | 0.024 | 0.165 |
| Comp. Example 2 | 3M 8142 | PMMA | 0.130 | −0.082 | 0.012 | 0.086 |
| Comp. Example 3 | Soken 1885 | MS | 0.143 | 0.033 | −0.064 | 0.105 |
| Comp. Example 4 | Soken 1885 | PC | 0.104 | −0.011 | −0.008 | 0.043 |
| Comp. Example 5 | Soken 1885 | PMMA | 0.176 | −0.052 | −0.026 | 0.152 |

1. NT = not tested

TABLE 6

| Sample | Adhesive | Substrate | Delta E* | Delta L* | Delta a* | Delta b* |
|---|---|---|---|---|---|---|
| Example 1 | Adhesive A | MS | 0.067 | 0.002 | 0.030 | −0.060 |
| Example 2 | Adhesive A | PC | 0.165 | 0.023 | 0.031 | −0.161 |
| Example 3 | Adhesive A | PMMA | 0.041 | −0.016 | −0.004 | −0.029 |
| Example 4 | Soken FP 7 | MS | 0.354 | −0.191 | 0.001 | 0.298 |
| Example 5 | Soken FP 7 | PC | 0.145 | −0.130 | 0.054 | 0.010 |
| Example 6 | Soken FP 7 | PMMA | 0.504 | −0.236 | −0.005 | 0.444 |
| Comp. Example 1 | 3M 9483 | PMMA | 0.058 | 0.003 | −0.026 | 0.046 |
| Comp. Example 2 | 3M 8142 | PMMA | NT | NT | NT | NT |
| Comp. Example 3 | Soken 1885 | MS | 0.048 | 0.046 | −0.006 | 0.009 |
| Comp. Example 4 | Soken 1885 | PC | 0.116 | 0.014 | −0.009 | −0.113 |
| Comp. Example 5 | Soken 1885 | PMMA | 0.156 | 0.024 | −0.048 | 0.145 |

1. NT = not tested

Transmission Measurements

The transmission levels were collected for several optical articles according to ASTM-D1003-00, entitled “Standard Test Method for Haze and Luminous Transmittance for Transparent Plastics.” The measurements were made using a BYK Gardner Haze-Gard Plus instrument, catalog no. 4723 and supplied by BYK Gardner, Silver Spring, Md. The instrument was referenced against air during the measurements. Results are shown in Table 7.

Brightness and Uniformity Measurements

The measurements of brightness and uniformity were performed on a specially designed LCD-TV experimental test bed. The test bed apparatus used two functioning parts: namely i) a 22″ Samsung LCD-TV, Model LTN226W, Model Code: LTN226WX/XAA, and ii) a goniometer stage. The goniometer stage allowed the LCD-TV to be moved from a horizontal position used for film loading, to a vertical position for the measurements. The LCD-TV was located about ˜15 feet (about 4.6 m) from a Radiant Imaging Prometric CCD Camera, Model 16111, obtainable from DuVall, Wash. The camera was provided with a Radiant Imaging Optical Filter, 72 mm ND 2.0. The Prometric camera luminance was calibrated using a Photo Research PR 650 (Chatsworth, Calif., SSN: 60964502). For the results reported in Table 7 below, the LC panel and absorbing polarizers had been removed from the LCD-TV, and the LCD-TV's backlight included an arrangement of eight parallel cold cathode fluorescent lamps.

The area luminance data obtained from the Prometric camera were averaged across one direction, parallel to the long axis of the cold cathode fluorescent lamps, and reported as the luminance in candelas per meter squared (cd/m²). The standard deviation, σ, in the brightness across the light management unit was collected on the same data to provide a metric for the uniformity. Results are reported in Table 7.

Half-Luminance Angle Measurements

The half-luminance angle measurement is a quantitative measurement of the degree of light diffusion of an optical material. This method describes a test method that measures the luminance distribution as a collimated light beam passes through an optical article. The following test method was used to quantify the half-luminance angle properties of several of the disclosed diffuse multilayer optical articles. All the half-angle luminance measurements were collected using an Autronics conoscope (Autronic-Melchers; Karlsruhe, Germany; Ergoscope serial number: M-CS-02-12-28). The optical article was placed on a specially designed fixture to hold the sample between the light source and the Autronic conoscope. The light source employed was a Fostec Hg arc source (150 watts, Auburn, N.Y., model: LR92240, serial number: 73643) that is integrated to the incident aperature using a flexible optical fiber. The incident aperature of the light source is positioned at normal incidence approximately 2.54 cm from the optical article. The aperature and sample are all leveled on the Autronic Conostage table (Conostage 3; serial number: M-CST3-02-12-01) using a circular level. After the sample and light source are leveled the Autronic conoscope is positioned to a distance of 2 mm from the top of the optical article sample. An internal reference material (IRM) is used to calibrate the device and is measured with each sample set. The Autronics collects the luminance distribution as the collimated light passes through the optical article.

½ D400 describes a 3 layer reflective polarizer construction. The construction consists of a 5 mil polycarbonate with 5% haze level (top layer)/UV adhesive layer (1 mil)/DBEF reflective polarizer layer. Cyro 020-4 is a commercially available PMMA diffuser plate that is sold by CYRO Industries.

The half-luminance angle is calculated using the following approach. The maximum intensity (Iₘₐₓ) is multiplied by 50%, giving the I_{1/2}, the “Half-Luminance Angle” value for the optical article. As the diffusion value of the optical article increases, the half-angle luminance value also increases. The half-luminance angle is calculated for both the vertical and horizontal directions, all the half-luminance angle values reported here are from the horizontal position. Measurement variation in the half-luminance angle values are +−5°.

For a given viewing direction, contrast ratio is defined as the ratio of the light intensity of the brightest white and darkest black capable of being displayed on a screen. Typically contrast ratio is measured for a specific location on the screen, with the display driven to brightest white and darkest black on separate occasions.

Results are reported in Table 7.

TABLE 7

| Reflective | Diffusing Layer | | | | | Uniformity, | |
|---|---|---|---|---|---|---|---|
| Polarizing | Adhesive | | | ½ | Axial | Merit | Contrast |
| Layer | Layer | Type | Transmission | Angle | Brightness | Function | Ratio |
| DBEF-Q | 3M 9483 | Cyro | 61% | 67° | 236 | 1.59% | 260 |
| | | 020-4 | | | | | |
| ½ D400 | 3M 9483 | Cyro | 61% | 67° | 226 | 1.64% | 272 |
| (12%) | | 020-4 | | | | | |
| ½ D400 | 3M 9483 | Cyro | 61% | 67° | 217 | 1.67% | 271 |
| (12%) | | 020-4 | | | | | |

Various modifications and alterations of this invention will be apparent to those skilled in the art without departing from the scope and spirit of this invention, and it should be understood that this invention is not limited to the illustrative embodiments set forth herein. All patents, patent application publications, and other patent and non-patent documents referred to herein are incorporated by reference, to the extent they are not inconsistent with the foregoing disclosure.

What is claimed is:

1. An optical article comprising:
a reflective polarizer;
a light diffusing layer; and
an adhesive layer disposed between the reflective polarizer and the light diffusing layer, wherein the adhesive layer bonds the reflective polarizer and the light diffusing layer together, wherein the adhesive comprises:
a (meth)acrylate monomer that has the formula: 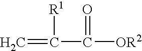
wherein R¹ is H or CH₃; and R² is a linear, branched, aromatic, or cyclic hydrocarbon group; and
a reinforcing monomer comprising an acid or base functionality, wherein the reinforcing monomer, as a homopolymer, has a Tg greater than about 20° C.

2. The optical article of claim 1 wherein the adhesive comprises a majority of the (meth)acrylate monomer.

3. The optical article of claim 1 wherein the adhesive further comprises a crosslinker.

4. The optical article of claim 1 wherein the R² is an alkyl group comprising from about 1 to about 20 carbon atoms.

5. The optical article of claim 1 wherein a standard deviation of luminance is less than about 3.0 cd/m².

6. The optical article of claim 1, wherein the reflective polarizer comprises a multilayer optical film of two or more alternating polymeric layers.

7. The optical article of claim 1, further comprising an additional layer disposed on the reflective polarizer opposite to the adhesive layer.

8. The optical article of claim 1, wherein the light diffusing layer comprises one or more polymeric layers.

9. The optical article of claim 1, wherein the light diffusing layer comprises polystyrene beads, polymethyl methylacrylate beads, polysiloxane beads, or combinations thereof.

10. The optical article of claim 1, wherein the light diffusing layer comprises one or more polymeric layers and a rigid or semi-rigid substrate.

11. The optical article of claim 1, wherein the light diffusing layer comprises a diffuser plate.

12. The optical article of claim 1 comprising a UV absorber selected from the group consisting of benzotriazoles, benzatriazines, and benzophenones, or combinations thereof.

13. The optical article of claim 1 comprising hindered amine light stabilizers, optical brighteners, phosphors, or combinations thereof.

14. The optical article of claim 1 wherein the light diffusing layer has a transmission of at least about 40% and a half angle of at least about 20°.

15. The optical article of claim 1 having a transmission of at least about 20% and a half angle of at least about 20°.

16. The optical article of claim 1, wherein after 500 hours at 85° C., Δb* is less than 2.0.

17. The optical article of claim 1, wherein after 500 hours at 65° C. and 95% relative humidity, Δb* is less than 2.0.

18. The optical article of claim 1, wherein after 288 hours at 80° C. and under fluorescent lighting, Δb* is less than 2.0.

19. The optical article of claim 1, wherein after 500 hours at 85° C., the optical article exhibits less than 20% change in transmission, half angle, axial brightness, uniformity merit function, contrast ratio, or combinations thereof.
